(19) United States
(12) Patent Application Publication
(10) Pub. No.: US 2006/0262671 A1
(43) Pub. Date: Nov. 23, 2006

(54) Recording medium recorder/player device

(76) Inventors: Hideo Morishita, Osaka (JP); Takayuki Deai, Osaka (JP)

Correspondence Address: PANASONIC PATENT CENTER;c/o MCDERMOTT WILL & EMERY LLP, 600 13TH STREET, NW, WASHINGTON, DC, 20005-3096, US

(21) Appl. No.: 11/436,650

(22) Filed: May 19, 2006

(30) Foreign Application Priority Data
May 20, 2005 (JP) 2005-147902

(51) Int. Cl. G11B 7/085

(52) U.S. Cl. 369/30.03

(57) ABSTRACT

Disc inherent information read from a disc, such as management information, etc., are stored in a disc inherent information storage memory. The time of opening/closing a tray close detection switch is determined from the timer value of a tray open/close time measurement timer. If this timer value is smaller than a prescribed time, the management information of the disc which has been loaded before a disc ejection process is read from the disc inherent information storage memory for resuming the play of the recording medium.

### CROSS-REFERENCE TO RELATED APPLICATIONS

This nonprovisional application claims priority under 35 U.S.C. §119(a) on Japanese Patent Application No. 2005-147902 filed on May 20, 2005, and the entire contents disclosed in the specification, drawings and claims of this application are hereby incorporated by reference.

### BACKGROUND OF THE INVENTION

The present invention relates to a recording medium recorder/player device capable of quick start-up even if a recording medium is erroneously ejected while being played.

In a conventional recording medium recorder/player device, when an ejection process of a recording medium loader is carried out in order to eject a recording medium which is being played, recording medium inherent information which has been read from the recording medium until the ejection process, various configurations which have been set according to a recording medium loaded into the device, learned data, etc., are all reset, whereby the device is initialized (see, for example, Japanese Laid-Open Patent Publication No. 5-159441).

### SUMMARY OF THE INVENTION

In such a conventional recording medium recorder/player device, even if a recording medium which has been ejected while being played in response to user's erroneous depressing of an ejection button is again loaded into the device, the play of the recording medium is not resumed from the point of interruption, but the recording medium recorder/player device is restarted with the initial state as is when a new recording medium is loaded. Therefore, a certain interval of time is expended for the start-up of the recording medium recorder/player device.

The present invention was conceived in view of the above circumstances. An objective of the present invention is to provide a recording medium recorder/player device wherein, when a recording medium erroneously ejected while being played is again loaded into the device, the play of the recording medium can be resumed from the point of interruption.

According to one aspect of the present invention, there is provided a recording medium recorder/player device for reading and playing data recorded in a recording medium, comprising: a memory for storing part of data read from the recording medium; an ejection operation time measurement timer for measuring an ejection operation time which is expended for moving a recording medium loader for loading the recording medium from a normal loading position to a normal ejection position; and a normal loading position detection switch for detecting the recording medium loader being at the normal loading position, wherein when, after an ejection operation of the recording medium loader, the normal loading position detection switch detects the recording medium loader being restored to the normal loading position again and the timer value of the ejection operation time measurement timer is smaller than a prescribed time, it is determined to be an error ejection of the recording medium, and data stored in the memory before the ejection of the recording medium loader from the normal loading position is read out for resuming the play of the recording medium.

Thus, according to the present invention, even when a user erroneously depresses an ejection button while audio/video information recorded in a recording medium, such as DVD, CD, or the like, is in the process of reproduction, the reproduction can be continued without any interruption of sound and video.

### BRIEF DESCRIPTION OF THE DRAWINGS

FIG. 1 is a block diagram showing a structure of a disc device according to an embodiment of the present invention.

FIG. 2 is a block diagram showing a structure of a disk drive according to an embodiment of the present invention.

FIG. 3 illustrates an address map in a DVD-ROM disc.

FIG. 4 is a flowchart illustrating a procedure in the disc device according to embodiment 1, which extends from tray closure to transfer of reproduction data to a reproduction device.

FIG. 5 is a flowchart illustrating a procedure in a disc device according to embodiment 2, which extends from tray closure to transfer of reproduction data to a reproduction device.

FIG. 6 is a flowchart illustrating a procedure in the disc device according to embodiment 3, which extends from tray closure to transfer of reproduction data to a reproduction device.

FIG. 7 is a flowchart illustrating a disc start-up process.

FIG. 8 is a flowchart illustrating a disc start-up process using error ejection determination processing.

FIG. 9 is a flowchart illustrating the error ejection determination processing.

FIG. 10 is a flowchart illustrating error ejection determination processing carried out with a plurality of conditions.

FIG. 11 illustrates transitions of the operation speed in a conventional disc device and in a disc device according to an embodiment of the present invention.

### DESCRIPTION OF THE PREFERRED EMBODIMENTS

Hereinafter, embodiments of the present invention will be described with reference to the drawings. It should be noted that the following descriptions of the preferred embodiments are merely exemplary in essence and are not intended to limit the present invention or the extent of applications and uses thereof. It should also be noted that the recording medium loader may be any of top-open type, tray type, slot-in type, etc.

### Embodiment 1

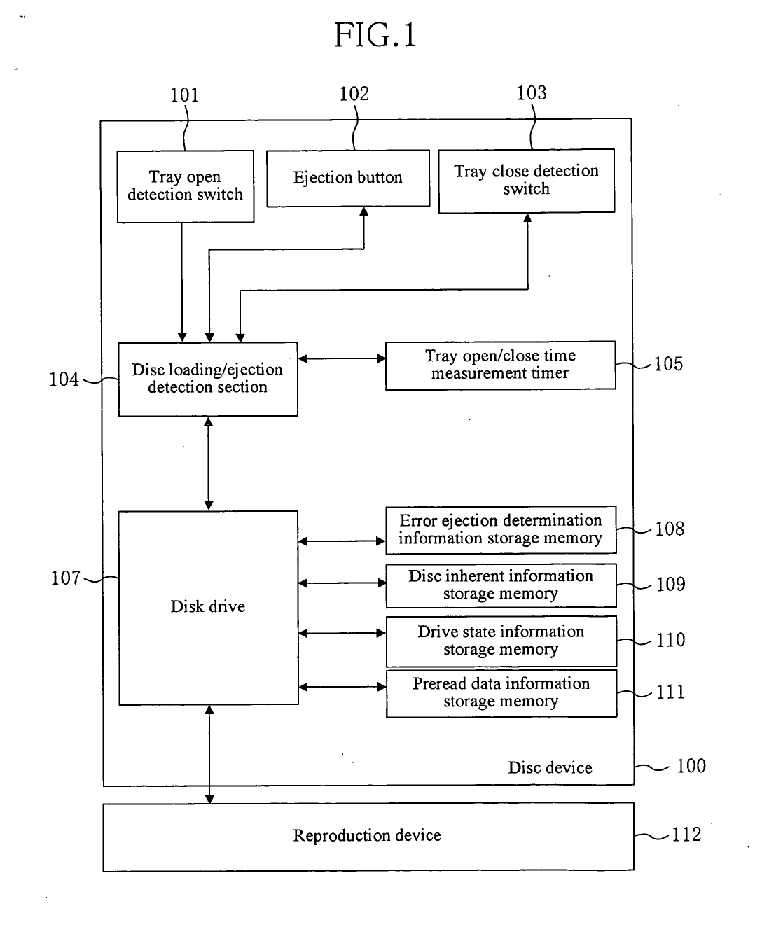

FIG. 1 is a block diagram showing a structure of a disc device according to embodiment 1 of the present invention. Referring to FIG. 1, a disc device 100 (recording medium recorder/player device) includes a tray open detection switch 101 for detecting a disc tray (recording medium loader) being at an open position, an ejection button 102 for ejecting or inserting the disc tray, a tray close detection switch 103 for detecting the disc tray being at a closed position, a disc loading/ejection detection section 104, a tray open/close time measurement timer 105, a disk drive 107, an error ejection determination information storage memory 108, a disc inherent information storage memory 109, a drive state information storage memory 110, and a preread data information storage memory 111.

Herein, the disc loading/ejection detection section 104 detects occurrence of loading or ejection of a disc to notify the disk drive 107 about the occurrence.

The disc device 100 transmits reproduction data to a reproduction device 112 for reproduction of disc data.

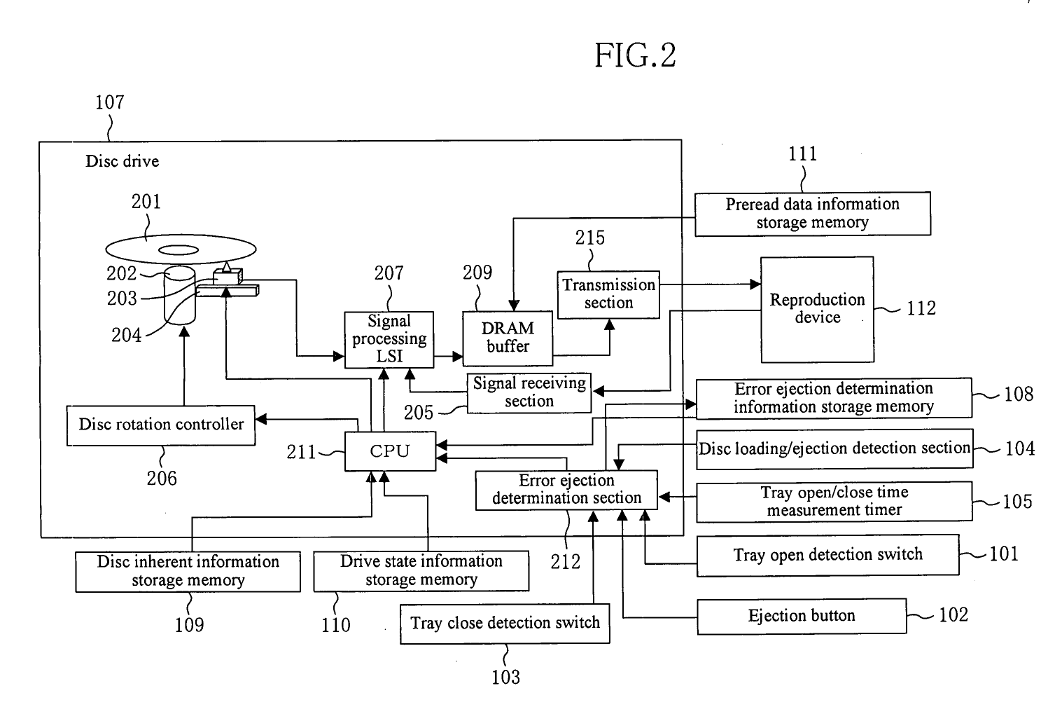

Referring to FIG. 2, the disk drive 107 includes a disc motor 202, an optical pickup 203, a sled 204, a signal receiving section 205, a disc rotation controller 206, a signal processing LSI 207, a DRAM buffer 209, a CPU 211, an error ejection determination section 212, and a transmission section 215.

Herein, an optical disc 201 (e.g., DVD-ROM disc) is a play-only recording medium containing video/audio information, which are reproduced by the reproduction device 112. It should be noted that the optical disc 201 is not limited to the play-only recording medium but may be a recordable recording medium containing some user data (e.g., DVD-R).

The disc motor 202 rotates the optical disc 201.

The CPU 211 controls the whole components of the disk drive 107, such as the optical pickup 203, the signal receiving section 205, the disc rotation controller 206, the signal processing LSI 207, the error ejection determination section 212, the transmission section 215, etc.

The optical pickup 203 reads data from the optical disc 201.

The sled 204 moves the optical pickup 203 according to the output of the CPU 211 to seek an address of designated data over the optical disc 201.

The signal receiving section 205 receives a signal transmitted from the reproduction device 112.

The disc rotation controller 206 controls the rotation of the disc motor 202 according to the output of the CPU 211.

The signal processing LSI 207 binarizes the signal read by the optical pickup 203 from the optical disc 201 to output the binary signal to the DRAM buffer 209.

The DRAM buffer 209 temporarily stores reproduction data which is to be transmitted to the reproduction device 112.

The error ejection determination section 212 operates as follows. When the value of the tray open/close time measurement timer 105 is equal to or greater than a prescribed time, the error ejection determination section 212 determines it to be a normal ejection operation. When the value of the tray open/close time measurement timer 105 is smaller than the prescribed time, the error ejection determination section 212 determines it to be an error ejection operation. Herein, the error ejection operation means an operation wherein the disc tray is ejected at a timing that a user does not desire because of mismanipulation of the user, or the like.

The transmission section 215 transmits data stored in the DRAM buffer 209 to the reproduction device 112.

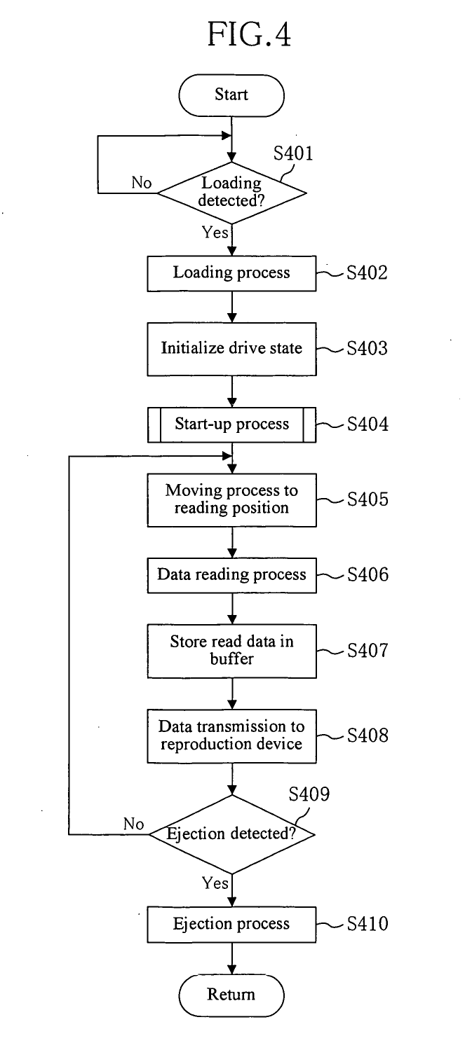

FIG. 4 is a flowchart illustrating an operation of the disc device according to embodiment 1. Referring to FIG. 4, first, at step S401, it is determined whether or not a disc is in a loaded state. If “NO” at step S401, the operation is on standby until detection of the loaded state. If “YES” at step S401, the operation branches to step S402.

At step S402, a loading process is carried out according to the output of the disc loading/ejection detection section 104. Then, the operation proceeds to step S403.

At step S403, the drive state is initialized. Then, the operation proceeds to step S404. At step S404, a start-up process (described later) is carried out. Then, the operation proceeds to step S405.

At step S405, a moving process is carried out to move the optical pickup 203 on the sled 204 to a reading position according to the output of the CPU 211 for seeking an address of designated data over the optical disc 201. Then, the operation proceeds to step S406.

At step S406, data which is to be reproduced is read from the optical disc 201. Then, the operation proceeds to step S407.

At step S407, the read data is stored in the DRAM buffer 209. Then, the operation proceeds to step S408.

At step S408, the data stored in the DRAM buffer 209 is transmitted to the reproduction device 112 through the transmission section 215. Then, the operation proceeds to step S409. This process of transmitting data to the reproduction device 112 enables reproduction of disc data.

At step S409, it is determined whether or not the disc loading/ejection detection section 104 has detected ejection of the disc. If “NO” at step S409, the operation branches to step S405, and the process of reading data from the optical disc 201 is continued.

If “YES” at step S409, the operation branches to step S410. At step S410, an ejection process is carried out to open the tray for ejection of the disc.

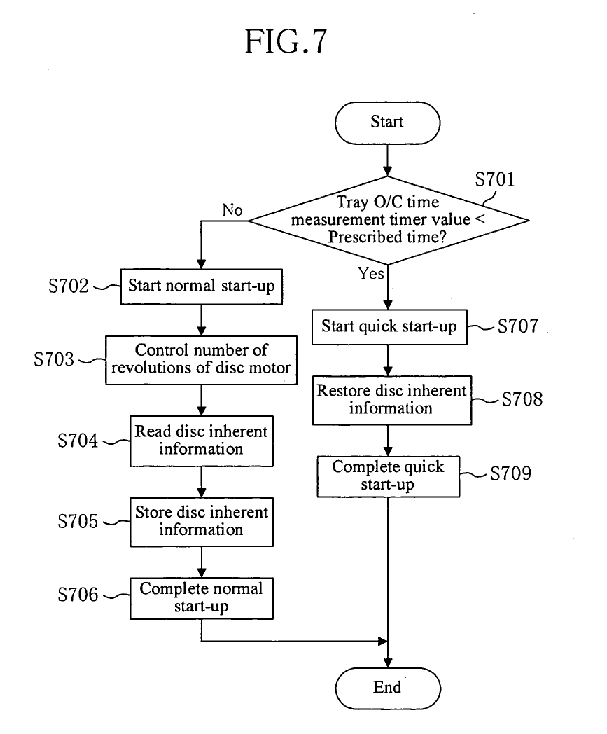

Next, a specific procedure of the start-up process of step S404 is described with reference to the flowchart of FIG. 7.

First, at step S701, the time of opening/closing of the tray close detection switch 103 is determined from the timer value of the tray open/close time measurement timer 105, and it is determined whether or not this timer value is smaller than the prescribed time.

If “YES” at step S701, the operation branches to step S707, at which a quick start-up process (described later) is started. If “NO” at step S701, the operation branches to step S702. At step S702, a normal start-up process is started. Then, the operation proceeds to step S703.

At step S703, the disc rotation controller 206 rotates the disc motor 202 to start up the optical disc 201. Then, the operation proceeds to step S704.

At step S704, the optical pickup 203 on the sled 204 is moved to an address in which management information of the optical disc 201 is recorded to read the management information from the optical disc 201. Then, the operation proceeds to step S705.

At step S705, disc inherent information, such as the read management information, and the like, are stored in the disc inherent information storage memory 109. Then, the operation proceeds to step S706. At step S706, the normal start-up process is completed.

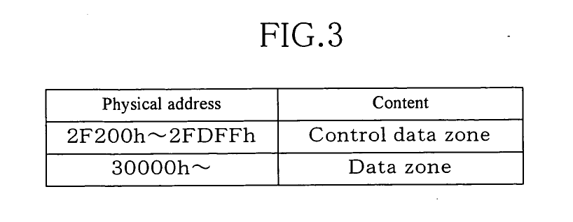

Herein, the management information means information indicative of the position of data, such as a picture recorded in the optical disc 201, and is necessary for reading data which is to be reproduced. For example, in the case of a DVD-ROM disc, information recorded in “Control Data Zone” shown in FIG. 3 is the management information.

The user data includes data which produce pictures and sounds when actually reproduced and a file system. The information recorded in “Data Zone” shown in FIG. 3 is the user data. For example, the file system includes information for identifying data which are to produce pictures and sounds, e.g., file names.

Meanwhile, at step S707, the quick start-up process is started. Then, the operation proceeds to step S708. At step S708, the disc inherent information which have already been stored in the disc inherent information storage memory 109, such as the management information, etc., are read out. Then, the operation proceeds to step S709. At step S709, the quick start-up process is completed.

According to embodiment 1, in the quick start-up process, the disc inherent information, such as the management information, and the like, are not read from the optical disc 201 but from the disc inherent information storage memory 109. Therefore, it is not necessary to acquire data from the disc, and the start-up time is shortened.

### Embodiment 2

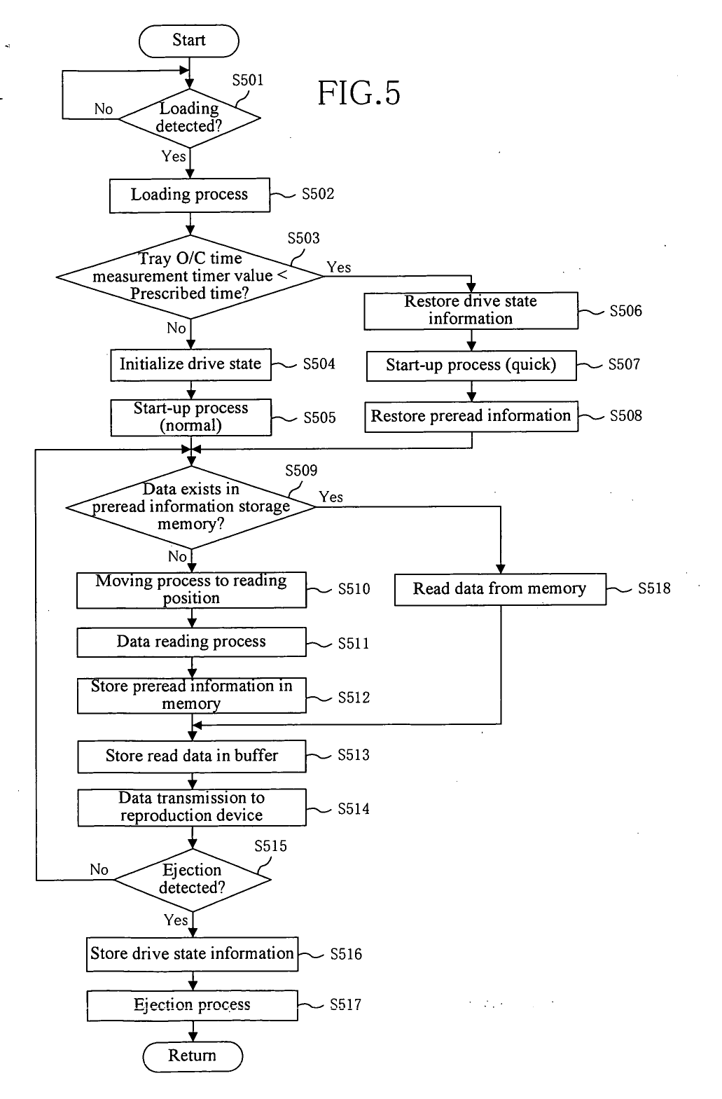

FIG. 5 is a flowchart illustrating an operation of the disc device according to embodiment 2. Referring to FIG. 5, first, at step S501, it is determined whether or not a disc is in a loaded state. If “NO” at step S501, the operation is on standby until detection of the loaded state. If “YES” at step S501, the operation branches to step S502.

At step S502, a loading process is carried out according to the output of the disc loading/ejection detection section 104. Then, the operation proceeds to step S503.

At step S503, the time of opening/closing of the tray close detection switch 103 is determined from the timer value of the tray open/close time measurement timer 105, and it is determined whether or not this timer value is smaller than the prescribed time.

If “YES” (error ejection) at step S503, the operation branches to step S506. At step S506, the configuration information about the drive state are read from the drive state information storage memory 110, and the drive state is restored to what it was before the ejection process. In this case, the drive state is not initialized or reset, and therefore, the time for setting the drive state is advantageously shortened.

Then, at step S507, the quick start-up process is started. The operation then proceeds to step S508. At step S508, preread information (described later) is restored to what it was before the ejection process. The operation then proceeds to step S509.

As described above, immediately after the start-up process carried out on the occurrence of an error ejection, data reproduction interrupted by the error ejection is resumed from the point of interruption. According to embodiment 2, on the occurrence of the error ejection, the data stored in the preread data information storage memory 111 is transferred to the DRAM buffer 209 immediately after the start-up process. Therefore, as for the data which exists in the preread data information storage memory 111, reproduction data can be transmitted to the reproduction device 112 without reading the data from the disc. With such an arrangement, the time required for resuming reproduction is shortened.

If “NO” at step S503, the operation branches to step S504. At step S504, the drive state is initialized. Then, the operation proceeds to step S505. At step S505, a normal start-up process is started. Then, the operation proceeds to step S509.

At step S509, it is determined whether or not data which is to be reproduced exists in the preread data information storage memory 111 (described later). If “YES” at step S509, the operation branches to step S518. At step S518, data is read from the preread data information storage memory 111. Then, the operation proceeds to step S512.

If “NO” at step S509, the operation branches to step S510. At step S510, a moving process is carried out to move the optical pickup 203 on the sled 204 to a reading position according to the output of the CPU 211 for seeking an address of designated data over the optical disc 201. Then, the operation proceeds to step S511.

At step S511, data which is to be reproduced is read from the optical disc 201. Then, the operation proceeds to step S512. At step S512, data existing in a region subsequent to the data which is to be reproduced is stored as preread information in the preread data information storage memory 111. Then, the operation proceeds to step S513.

Then, at step S513, the read data is stored in the DRAM buffer 209. Then, the operation proceeds to step S514.

At step S514, the data stored in the DRAM buffer 209 is transmitted to the reproduction device 112 through the transmission section 215. Then, the operation proceeds to step S515. This process of transmitting data to the reproduction device 112 enables reproduction of disc data.

At step S515, it is determined whether or not the disc loading/ejection detection section 104 has detected ejection of the disc. If “NO” at step S515, the operation branches to step S509, and the process of reading data from the optical disc 201 is continued.

If “YES” at step S515, the operation branches to step S516. At step S516, drive state information indicative of the current drive state is stored in the drive state information storage memory 110. Then, the operation proceeds to step S517.

At step S517, an ejection process is carried out to open the tray for ejection of the disc.

### Embodiment 3

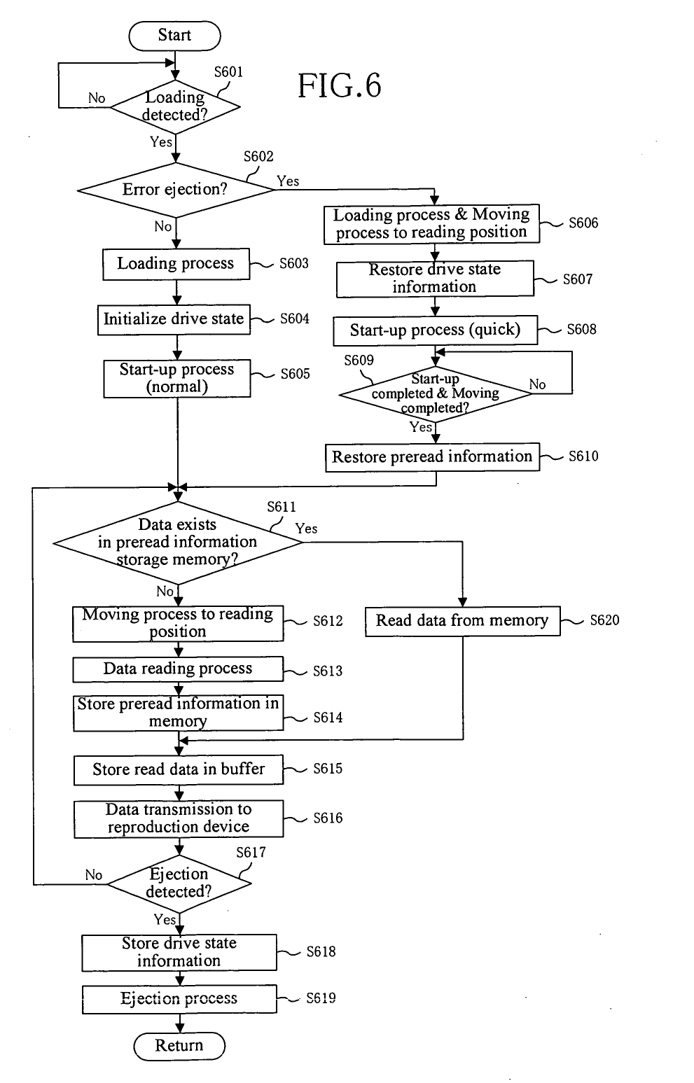

FIG. 6 is a flowchart illustrating an operation of a disc device according to embodiment 3. Referring to FIG. 6, first, at step S601, it is determined whether or not a disc is in a loaded state. If “NO” at step S601, the operation is on standby until detection of the loaded state. If “YES” at step S601, the operation branches to step S602.

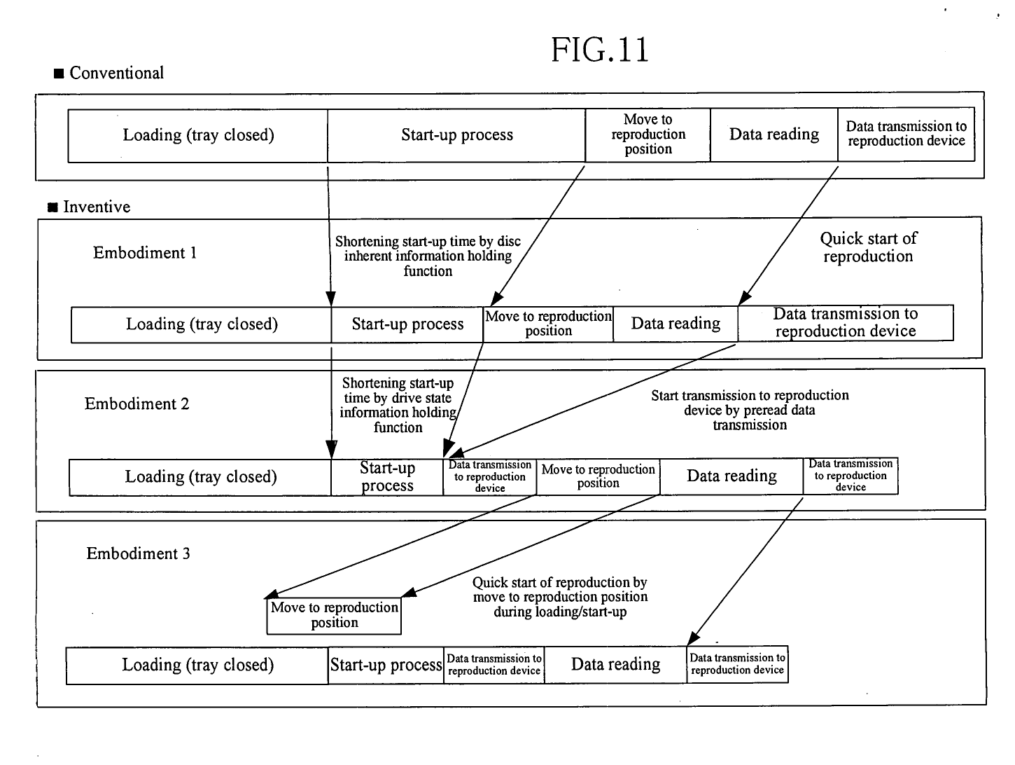

At step S602, it is determined, based on a determination procedure (described later) in the error ejection determination section 212, whether or not an error ejection has occurred. If “YES” (error ejection) at step S602, the operation branches to step S607. At step S607, the process of moving the optical pickup 203 to a data reading position over the optical disc 201 is performed along with the loading process which is carried out based on the output of the disc loading/ejection detection section 104. With such an arrangement, the time expended before resumption of reproduction is shortened as illustrated in FIG. 11.

Then, at step S607, the configuration information about the drive state are read from the drive state information storage memory 110, and the drive state is restored to what it was before the ejection process. In this case, the drive state is not initialized or reset, and therefore, the time for setting the drive state is advantageously shortened.

Then, at step S608, the quick start-up process is started. The operation then proceeds to step S609. At step S609, it is determined whether or not the start-up process has been completed and the optical pickup 203 has been moved to the reading position. If “NO” at step S609, the operation is on standby until completion of the process. If “YES” at step S609, the operation branches to step S610. At step S610, preread information (described later) is restored to what it was before the ejection process. The operation then proceeds to step S611.

As described above, immediately after the start-up process carried out on the occurrence of an error ejection, data reproduction interrupted by the error ejection is resumed from the point of interruption. According to embodiment 3, on the occurrence of the error ejection, the data stored in the preread data information storage memory 111 is transferred to the DRAM buffer 209 immediately after the start-up process. Therefore, as for the data which exists in the preread data information storage memory 111, reproduction data can be transmitted to the reproduction device 112 without reading the data from the disc. With such an arrangement, the time required for resuming reproduction is shortened.

If “NO” at step S602, the operation branches to step S603. At step S603, a loading process is carried out according to the output of the disc loading/ejection detection section 104. Then, the operation proceeds to step S604.

At step S604, the drive state is initialized. Then, the operation proceeds to step S605. At step S605, a normal start-up process is started. Then, the operation proceeds to step S611.

At step S611, it is determined whether or not data which is to be reproduced exists in the preread data information storage memory 111 (described later). If “YES” at step S611, the operation branches to step S620. At step S620, data is read from the preread data information storage memory 111. Then, the operation proceeds to step S615.

If “NO” at step S611, the operation branches to step S612. At step S612, a moving process is carried out to move the optical pickup 203 on the sled 204 to a reading position according to the output of the CPU 211 for seeking an address of designated data over the optical disc 201. Then, the operation proceeds to step S613.

At step S613, data which is to be reproduced is read from the optical disc 201. Then, the operation proceeds to step S614. At step S614, data existing in a region subsequent to the data which is to be reproduced is stored as preread information in the preread data information storage memory 111. Then, the operation proceeds to step S615.

Then, at step S615, the read data is stored in the DRAM buffer 209. Then, the operation proceeds to step S616.

At step S616, the data stored in the DRAM buffer 209 is transmitted to the reproduction device 112 through the transmission section 215. Then, the operation proceeds to step S617. This process of transmitting data to the reproduction device 112 enables reproduction of disc data.

At step S617, it is determined whether or not the disc loading/ejection detection section 104 has detected ejection of the disc. If “NO” at step S617, the operation branches to step S611, and the process of reading data from the optical disc 201 is continued.

If “YES” at step S617, the operation branches to step S618. At step S618, drive state information indicative of the current drive state is stored in the drive state information storage memory 110. Then, the operation proceeds to step S619.

At step S619, an ejection process is carried out to open the tray for ejection of the disc.

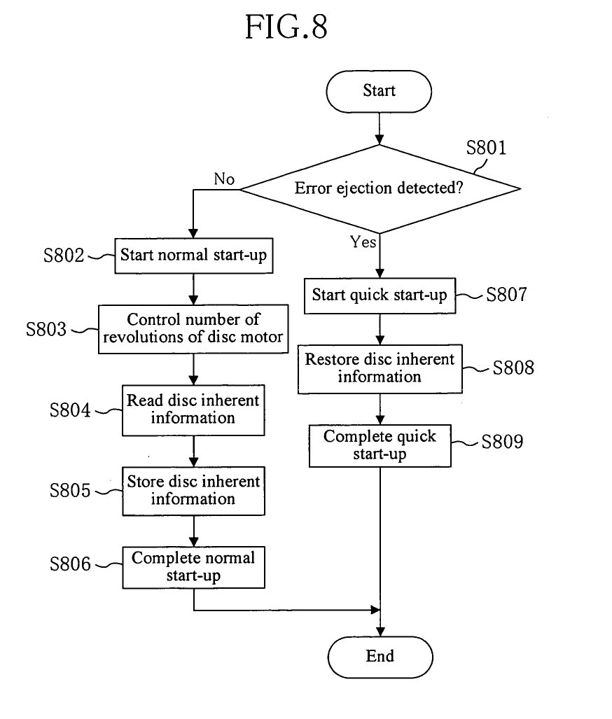

Next, a specific procedure of the start-up processes of steps S605 and S608 is described with reference to the flowchart of FIG. 8.

First, at step S801, it is determined, based on an error ejection determination procedure (described later), whether or not an error ejection has been detected.

If “YES” at step S801, the operation branches to step S807, at which a quick start-up process (described later) is started. If “NO” at step S801, the operation branches to step S802. At step S802, a normal start-up process is started. Then, the operation proceeds to step S803.

At step S803, the disc rotation controller 206 rotates the disc motor 202 to start up the optical disc 201. Then, the operation proceeds to step S804.

At step S804, the optical pickup 203 on the sled 204 is moved to an address in which management information of the optical disc 201 is recorded to read the management information from the optical disc 201. Then, the operation proceeds to step S805.

At step S805, disc inherent information, such as the read management information, and the like, are stored in the disc inherent information storage memory 109. Then, the operation proceeds to step S806. At step S806, the normal start-up process is completed.

Meanwhile, at step S807, the quick start-up process is started. Then, the operation proceeds to step S808. At step S808, the disc inherent information which have already been stored in the disc inherent information storage memory 109, such as the management information, etc., are read out. Then, the operation proceeds to step S809.

At step S809, the quick start-up process is completed.

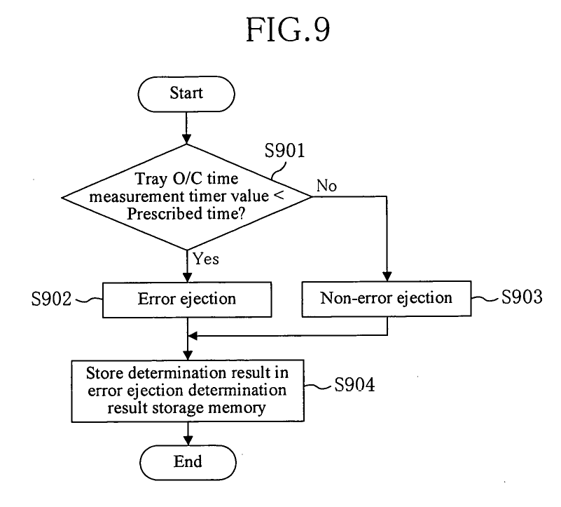

Next, a specific procedure of the error ejection determination process carried out in step S602 is described with reference to the flowchart of FIG. 9.

First, at step S901, the time of opening/closing of the tray close detection switch 103 is determined from the timer value of the tray open/close time measurement timer 105, and it is determined whether or not this timer value is smaller than the prescribed time.

If “YES” at step S901, the operation branches to step S902. At step S902, it is determined to be an error ejection. Then, the operation proceeds to step S904.

If “NO” at step S901, the operation branches to step S903. At step S903, it is determined to be a non-error ejection. Then, the operation proceeds to step S904.

At step S904, the determination result is stored in the error ejection determination information storage memory 108, and the operation is ended. Thus, even in the case where there are a plurality of signals for determining error ejection, when the need for the error ejection determination result arises after determination of error ejection, it is advantageously only necessary to acquire the determination result stored in the error ejection determination information storage memory 108.

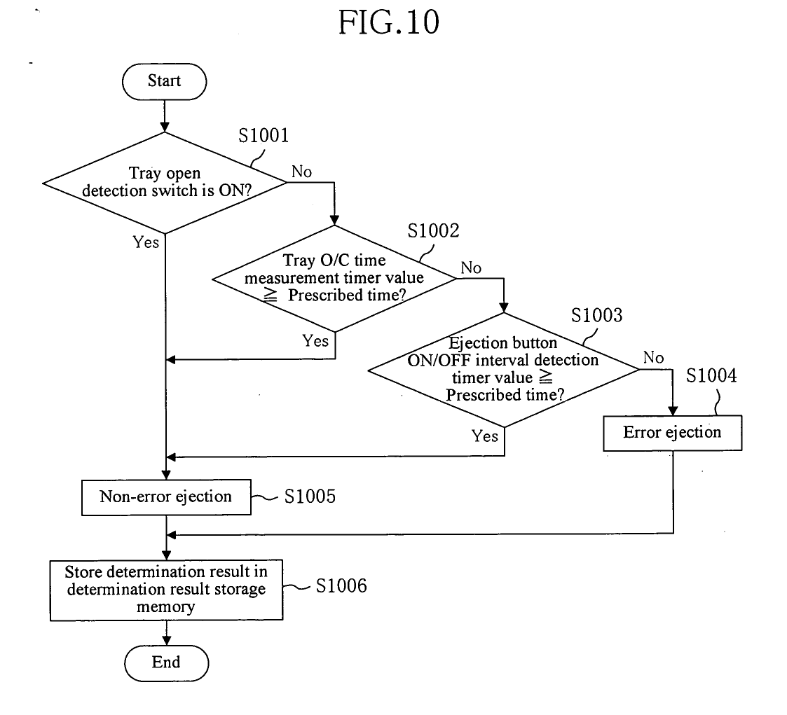

Next, another example of the error ejection determination procedure carried out in step S602 is described with reference to the flowchart of FIG. 10. In the procedure illustrated in FIG. 10, error ejection is determined using a plurality of conditions.

First, at step S1001, it is determined whether or not the tray open detection switch 101 is ON. If “YES” at step S1001, the operation branches to step S1005. At step S1005, it is determined to be a non-error ejection.

If “NO” at step S1001, the operation branches to step S1002. At step S1002, the time of opening/closing of the tray close detection switch 103 is determined from the timer value of the tray open/close time measurement timer 105, and it is determined whether or not this timer value is equal to or greater than the prescribed time.

If “YES” at step S1002, the operation branches to step S1005. At step S1005, it is determined to be a non-error ejection.

If “NO” at step S1002, the operation branches to step S1003. At step S1003, it is determined whether or not the timer value of an ejection button ON/OFF interval detection section (not shown), which measures the time interval in which the ejection button is ON or OFF, is equal to or greater than a prescribed time.

If “YES” at step S1003, the operation branches to step S1005. At step S1005, it is determined to be a non-error ejection.

If “NO” at step S1003, the operation branches to step S1004. At step S1004, it is determined to be an error ejection. Then, the operation proceeds to step S1006.

At step S1006, the determination result is stored in the error ejection determination information storage memory 108, and the operation is ended.

As described above, error ejection is determined using a plurality of conditions, and therefore, the accuracy in determination of error ejection can be improved.

Further, by shortening the drive state setting time, increasing the start-up speed, shortening the time of reading disc management information, increasing the speed of reading data from a disc using preread information, and shortening the data reading time by performing transfer of a pickup to a data reading position and loading of a disc in parallel, continuous reproduction is realized without interruption in pictures or sounds even if an error ejection occurs during the play of a disc.

As described above, the present invention provides an eminently practical effect such that, when a recording medium erroneously ejected during the play thereof is loaded again, the play can be resumed from the point of interruption, and is therefore extremely useful and possesses high industrial applicability.

What is claimed is:

1. A recording medium recorder/player device for reading and playing data recorded in a recording medium, comprising:
a memory for storing part of data read from the recording medium;
an ejection operation time measurement timer for measuring an ejection operation time which is expended for moving a recording medium loader for loading the recording medium from a normal loading position to a normal ejection position; and
a normal loading position detection switch for detecting the recording medium loader being at the normal loading position, wherein
when, after an ejection operation of the recording medium loader, the normal loading position detection switch detects the recording medium loader being restored to the normal loading position again and the timer value of the ejection operation time measurement timer is smaller than a prescribed time, it is determined to be an error ejection of the recording medium, and data stored in the memory before the ejection of the recording medium loader from the normal loading position is read out for resuming the play of the recording medium.

2. The recording medium recorder/player device of claim 1, further comprising a normal ejection position detection switch for detecting the recording medium loader being at the normal ejection position, wherein
when, after the ejection operation of the recording medium loader, the normal loading position detection switch detects the recording medium loader being restored to the normal loading position again before the position of the recording medium loader is detected by the normal ejection position detection switch, it is determined to be an error ejection, and the data stored in the memory before the ejection of the recording medium loader is read out for resuming the play of the recording medium.

3. The recording medium recorder/player device of claim 1, further comprising a buffer memory for storing data indicative of a drive operation state detected before the ejection of the recording medium loader and data preread from the recording medium,
wherein if it is determined to be the error ejection, the data stored in the buffer memory are read out for resuming the play of the recording medium.

4. The recording medium recorder/player device of claim 3, further comprising an error ejection determination section for determining whether or not opening/closing of the recording medium loader is an error ejection,
wherein if the error ejection determination section determines it to be an error ejection, the data indicative of the drive operation state stored in the buffer memory before the ejection of the recording medium loader is read out for resuming the play of the recording medium during transfer of the recording medium loader to the normal loading position.
